(19) United States
(12) Patent Application Publication
(10) Pub. No.: US 2008/0080172 A1
(43) Pub. Date: Apr. 3, 2008

(54) Hunting apparel with indicator lights

(76) Inventors: Bo Mayo, Kosciusko, MS (US); Daniel Gove, West, MS (US); Vickie Gove, West, MS (US)

Correspondence Address: STOCKWELL & SMEDLEY, PSC, 861 CORPORATE DRIVE, SUITE 200, LEXINGTON, KY, 40503, US

(21) Appl. No.: 11/904,973

(22) Filed: Sep. 28, 2007

Related U.S. Application Data
(60) Provisional application No. 60/848,225, filed on Sep. 29, 2006.

(51) Int. Cl. F21V 21/084; F21V 21/08

(52) U.S. Cl. 362/106; 362/108

(57) ABSTRACT

Outdoor apparel includes at least one LED panel, and preferably more, comprised of plural high-visibility LEDs. The panels may operate in various modes such as steady, slow-blink, and fast-blink. Different color LEDs are also contemplated based on different intended uses.

### RELATED APPLICATIONS

This application claims priority to U.S. Application Ser. No. 60/848,225 filed Sep. 29, 2006, the disclosure of which is incorporated herein by reference in its entirety.

### FIELD OF THE INVENTION

This invention relates generally to hunting apparel, and more specifically to including user-operable indicator lights within the apparel.

### BACKGROUND

Occasionally, hunters are shot or mistaken for game, particularly when ambient light and visibility are limited. Consequently, a means of more accurately identifying hunters is desired. Additionally, hunters may sometimes become lost or injured in the woods and locating them in dark, dusky, foggy, or low-light conditions is sometimes difficult. Normal reflective gear or regular intensity flashlights are inadequate to provide adequate assistance to search and rescue personnel. Also, in many instances such as climbing or descending from a tree stand or locating dropped personal articles, a hunter's safety and effectiveness are adversely impacted by the absence of a hands-free, bright light source. Accordingly, there remains a need in the art for an apparatus to address these problems experienced by hunters and other people that may venture far away from urban comfort.

### SUMMARY

Embodiments of the present invention relate to

It is understood that other embodiments of the present invention will become readily apparent to those skilled in the art from the following detailed description, wherein it is shown and described only various embodiments of the invention by way of illustration. As will be realized, the invention is capable of other and different embodiments and its several details are capable of modification in various other respects, all without departing from the spirit and scope of the present invention. Accordingly, the drawings and detailed description are to be regarded as illustrative in nature and not as restrictive.

### BRIEF DESCRIPTION OF THE DRAWINGS

FIG. 1 shows a front view of a vest designed in accordance with the principles of the present invention;

FIG. 2 shows a rear view of the vest of FIG. 1; and

FIG. 3 shows headgear designed in accordance with the principles of the present invention.

### DETAILED DESCRIPTION

The detailed description set forth below in connection with the appended drawings is intended as a description of various embodiments of the invention and is not intended to represent the only embodiments in which the invention may be practiced. The detailed description includes specific details for the purpose of providing a thorough understanding of the invention. However, it will be apparent to those skilled in the art that the invention may be practiced without these specific details. In some instances, well known structures and components are shown in block diagram form in order to avoid obscuring the concepts of the invention.

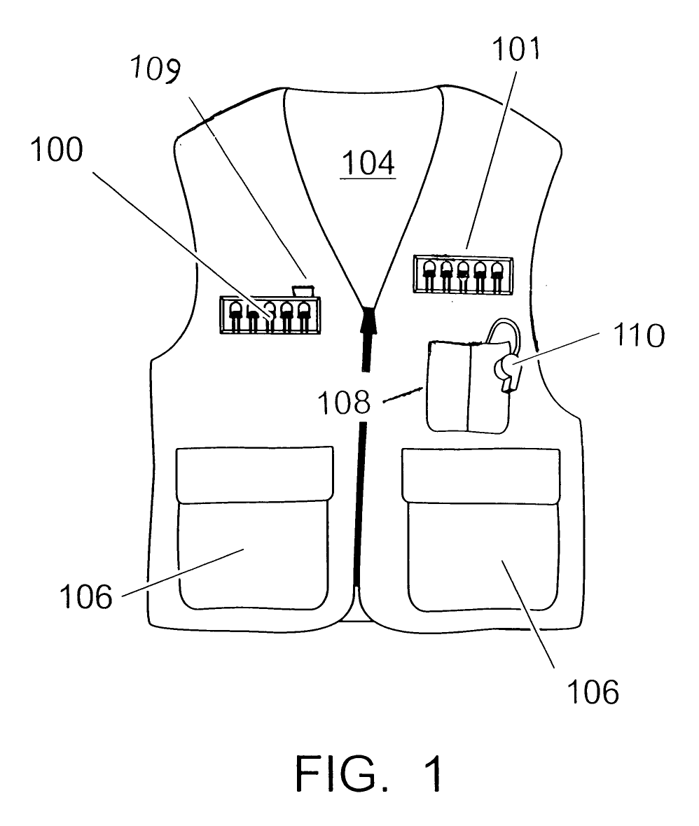

FIG. 1 shows a front view of the vest 104 of the present invention containing an LED panel 100 and another LED panel 101. However, embodiments of the present invention also contemplate only one LED panel located on either the left or right side of the vest. The vest 104 may also include a pocket 108 for a cell phone for example. There may also be included a whistle, or other signaling mechanisms, and lanyard attachment 110; although, this attachment is not required in all embodiments of the present invention. To further enhance the utility of the vest 104, additional pockets 106 may be included as appropriate. Although the clothing of FIG. 1 is specifically a vest, a jacket embodiment (not shown) is also contemplated within the spirit and scope of the present invention. As for color, the vest 104 (or jacket) can be provided in camouflage color, hunter's orange, or other colors as well.

The LED panels 100 and 101 are depicted in the figure as having five separate LEDs. One of ordinary skill will recognize that the specific number of LEDs may vary without departing from the scope of the present invention; for example, three LEDs may be used without departing from the scope of the present invention. Also, the number of LEDs in the panels 100 and 101 do not necessarily have to be equal. To achieve the purpose of making the vest 104 easily visible from a great distance, fewer or more individual LEDs may be used depending on their brightness characteristics.

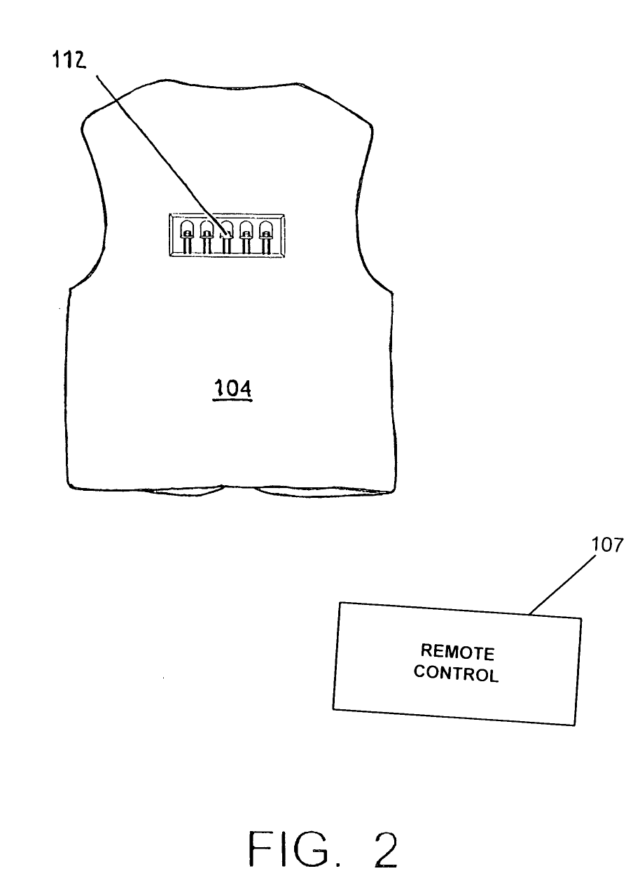

FIG. 2 shows an LED panel 112 that is located on the back of the vest 104. The present invention contemplates locating the LED panels on either the back or front of the vest 104, or both. By selecting currently available high-intensity, or high-visibility LEDs, the light from the LEDs of the vest 104 can be easily seen from a distance of up to approximately one mile. Even brighter LEDs will allow detection from greater distances. One of ordinary skill will readily recognize that the design of the LED panels may contemplate both LED intensity and power conservation. Accordingly, a compromise between safety and energy efficiency will allow many different configurations without departure from the scope of the present invention.

The LED panels, panel 100 for example, may be configured to have three different settings: slow blink, continually on, and fast blink. The different modes of operation can be useful in different scenarios. For example, the slow blink may indicate the user is walking or is stationary. With the help of the blinking LED panels, other hunters are unlikely to confuse the vest wearer with a viable target. The fast blink mode can be useful in rescue or emergency situations where locating the wearer as quickly as possible is important. The steady mode is useful for providing area lighting in a hands-free manner to the user.

A battery-powered remote control 107 (either wired or wireless) for activating the LED panels can fit into a pocket of the vest, or any other pocket, for easy access. The remote control will allow the user to select the desired mode of operation for the LED panels and also power them off as well. The remote control can be configured so that all the LED panels operate in the same mode or, alternatively, the front panels 100, 101 can be controlled so as to operate in a different mode than the rear panel 112. In addition to, or instead of, the remote control 107, the LED panels 100, 101, and 112 can also be operated with by buttons 109 directly connected thereto. In FIG. 1, the panel 100 is depicted as having a control button 109. Through this button 109, the operation of all LED panels is controlled. Thus, some type of signaling wire is connected between the different LED panels to provide control signals. If desired, each LED panel could, alternatively, have its own, separate control button (not shown), thereby avoiding such interconnected control wires.

Because the jacket and vest 104 may be machine washable, the LED panels can be integrated and waterproofed in such a way that it can be sewn into the surface of the jacket and vest. Alternatively, the LED panels can be detached such as through VELCRO™ or other securing device. The jacket or vest could also come with a safety harness or strap. Safety back packs or fanny packs can also be included.

The vest 104 can be employed by hunters either prior to or after a hunting task; in other words where a hunter is not directly involved in the hunting process. However, where use of the LED panels occurs while actively hunting, a green-light embodiment is contemplated. This is useful because most deer cannot see the color green. Thus, a hunter could be using the LED panels without alerting deer. Depending on the particular game being hunted, LEDs of invisible wavelengths for that game may be selected. In this instance, then, detachable and substitutable LED panels of different colors are particularly beneficial.

Each of the LED panels may include a battery pack for supplying power to the LED panel. Various embodiments of the present invention contemplate a battery pack that is detachable from an LED panels or a battery pack integrally formed with the LED panel. The battery pack, for instance, may be a rechargeable element, may be comprised of replaceable cells (e.g. standard AA batteries), or may be comprised of replaceable, rechargeable cells. A central battery pack is also contemplated as an alternative to individual battery packs for each LED panel. In such an embodiment, wires from the central battery pack are connected to the LED panels. In practice, these wires would be routed unobtrusively along seams or other natural pathways in the vest. For a detachable battery pack, a power port or interface on the LED panels should include some type of sealing mechanism to seal the port prior to immersion in a washing machine.

The LED is meant to be seen by others, but can also help the wearer navigate in thick wilderness while darkness is occurring. Another example of this is in climbing out of a tree stand or blind, and locating the ladder-steps, etc, after dusk when hunting has ceased, or before dawn before hunting begins. In both case, limited or no daylight is available. Thus, temporarily activating one or more of the LED panels (perhaps in the “steady” mode) could help a hunter safely ascend to or descend from a the stand in limited light conditions.

As stated, because deer cannot see the color green, during use of the green-LED embodiment, the deer are not distracted or alerted to the presence of a hunter. Thus, embodiments of the present invention can assist in reducing the number of hunting accidents, as the LED panels may help reduce the amount of mistaken-identity injuries.

The LED panels can also assist in reducing hunters getting lost, could help them find the right tree, and will increase safety for youthful or inexperienced hunters. The LED panels can further be combined with a GPS chip so that any hunter can be located regardless of how vast the hunting area. However, the lights can be de-activated so that they do not alert deer, which have a tendency to be attracted by lights. In an optimal environment, the size of the battery pack and the LED panels are sized so that the battery pack can last up to 400 hours of continuous operation.

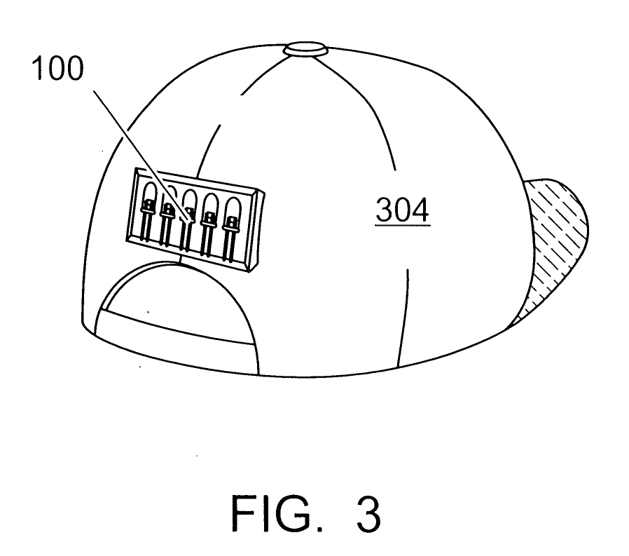

As shown in FIG. 3, a cap 304 having an LED panel 100 is also contemplated within the spirit and scope of the present invention. The cap 304 can also be manufactured in a variety of colors, including but not limited to camouflage color or orange. The limited amount of light given off by the LED panel 100 could be sufficient to help a hunter walk out of the woods at dusk or dark. However, due to the penetrating nature of currently available, high intensity LEDs contemplated within the present invention, the faster-beating configuration can be seen up to one mile away. These high visibility LEDs are composed of a material which is conducive to high-penetration light beams yet with minimal power consumption.

In a non-hunting aspect, the present invention could also be suitable for construction workers who must work at night. Other uses contemplated within the spirit and scope of the present invention include being used by cyclists, joggers, government employees such as police and fire protection, military employees, can all use the present invention. In all cases, there may be circumstances where these persons may at times which to be visible, and then other times where they wish to not be visible.

The previous description is provided to enable any person skilled in the art to practice the various embodiments described herein. Various modifications to these embodiments will be readily apparent to those skilled in the art, and the generic principles defined herein may be applied to other embodiments. Thus, the claims are not intended to be limited to the embodiments shown herein, but are to be accorded the full scope consistent with each claim's language, wherein reference to an element in the singular is not intended to mean “one and only one” unless specifically so stated, but rather “one or more.” All structural and functional equivalents to the elements of the various embodiments described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A device comprising:
an article of clothing configured for a torso of a human wearer;
at least one LED panel comprised of plural high-visibility LEDs;
a control mechanism configured to permit the wearer to control operation of the at least one LED panel; and
a battery pack configured to provide power to the at least one LED panel.

2. The device of claim 1, wherein the at least one LED panel includes a first LED panel on a front of the article of clothing.

3. The device of claim 1, wherein the at least one LED panel includes a first LED panel on a back of the article of clothing.

4. The device of claim 1, wherein the at least one LED panel includes a first LED panel on a front of the article of clothing and a second LED panel on a back of the article of clothing.

5. The device of claim 1, wherein the at least one LED panel includes a first LED panel on a right side on a front of the article of clothing and a second LED panel on a left side on a back of the article of clothing.

6. The device of claim 1, wherein the at least one LED panel includes a first LED panel on a right side on a front of the article of clothing, a second LED panel on a left side on a back of the article of clothing, and a third LED panel on a back of the article of clothing.

7. The device of claim 1, wherein the article of clothing comprises a vest.

8. The device of claim 1, wherein the article of clothing comprises a jacket.

9. The device of claim 1, wherein the control mechanism is a remote control.

10. The device of claim 9, wherein the remote control wirelessly communicates with the at least one LED panel.

11. The device of claim 1, wherein the at least one LED panel includes a first and second LED panel.

12. The device of claim 11, wherein the control mechanism is attached to the first LED panel and controls both the first and second LED panels.

13. The device of claim 11, wherein the control mechanism has a first portion attached to the first LED panel and controlling the operation of the first LED panel and a second portion attached to the second LED panel and controlling the operation of the second LED panel.

14. The device of claim 1, wherein the at least one LED panel includes multiple modes of operation.

15. The device of claim 14, wherein the at least one LED panel includes at least three modes of operation: a steady mode, a fast-blink mode; and a slow-blink mode.

16. The device of claim 1, wherein the at least one LED panel is removable from the article of clothing.

17. The device of claim 1, wherein the at least one LED panel is integrally formed in the article of clothing.

18. The device of claim 1, wherein the battery pack is configured to provide continuous operation of the at least one LED panel for at least approximately 400 hours.

19. The device of claim 1, wherein the at least one LED panel has a visible range of at least approximately one mile.

20. The device of claim 1, wherein the article of clothing is a hat.
